(19) United States
(12) Patent Application Publication
(10) Pub. No.: US 2006/0034515 A1
(43) Pub. Date: Feb. 16, 2006

(54) Safety souvenir

(76) Inventor: Christopher P. Geisert, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/910,683

(22) Filed: Aug. 3, 2004

(51) Int. Cl. G06K 9/00

(52) U.S. Cl. 382/181

(57) ABSTRACT

A method for preventing child abductions from a group of individuals seeking admittance to a controlled access environment including the steps of: imaging a first group of individuals; creating a visual representation of the first group; providing at least one member of the first group with the visual representation; allowing the first group access; comparing the number of individuals in the provided visual representation against the number of individuals in a second group exiting the controlled access environment, wherein if the number of individuals in the group seeking to exit the controlled access environment is the same as the number that were present upon entering the controlled access environment, the group exiting is allowed to exit the controlled access environment; otherwise, the group of individuals seeking to exit the controlled access environment is detained for further investigation.

### FIELD OF THE INVENTION

The present invention relates to a method of increasing security at a controlled access environment, and more particularly to a method of preventing abductions from a controlled access environment.

### BACKGROUND OF THE INVENTION

Controlled access environments are environments or surroundings wherein access thereto is restricted. For example, water parks, amusement parks, theme parks, and museums are examples of such environments whereby tickets are sold, thereby restricting access to paying customers. In addition to controlling access to paying customers, access may also be restricted for other reasons such as security issues, organizational issues and the like. In such controlled environments, the restrictions are typically imposed in order to limit access to the establishment and/or surroundings to paying patrons.

Regardless of the reason for restricting access to the surroundings and/or establishment, the patrons typically feel a sense of security when inside the establishment due to the restricted access. For example, when a group of patrons or more specifically a group of family members attends an amusement park, access is restricted to paying customers. Because the access is restricted, the members in charge of the group (for example the parents) may have a heightened sense of security. This is in large part due to the parents believing that the younger members of the group, even if lost within the park, will not be removed therefrom. Compounding this false sense of security are the demands on the members of the group for their attention by the various aspects of the amusement park which acts to reduce the guard and/or awareness of the members of the group. Unfortunately many pedophiles and/or child abductors are keenly aware of these facts and frequent these places to conduct their criminal conduct.

Therefore, a need exist for a method of increasing the security at these controlled access sites, thereby reducing or preventing abductions.

### SUMMARY OF THE INVENTION

One aspect of the present invention is to provide a method for preventing child abductions from a group of individuals seeking admittance to a controlled access environment and includes the steps of: imaging a first group of individuals seeking access to a controlled access environment; creating a visual representation of the first group; allowing the first group access to the controlled environment; and comparing the individuals in the visual representation against the individuals in a second group seeking to exit the controlled access environment, thereby ensuring that the same individuals present in the group exiting the controlled access environment are the same as those that were present upon entering the controlled access environment, wherein if the number of individuals in the group seeking to exit the controlled access environment is the same as those present upon entering the controlled access environment, the group seeking to exit is allowed to exit the controlled access environment.

Another aspect of the present invention is to provide a method of preventing child abductions from a group of individuals seeking admittance to a controlled access environment and includes: providing one or more authorized individuals and an environment; restricting access to the environment by the one or more authorized individuals, thereby defining a controlled access environment; imaging a group of individuals seeking to access the controlled access environment; creating a visual representation of the group; providing at least one member of the group with the visual representation; allowing the group access to the controlled access environment, whereby when the group seeks to exit the controlled access environment the group presents the visual representation to one or more of the authorized individuals; and comparing the individuals in the group seeking to exit the controlled access environment with the individuals depicted in the provided visual representation, thereby ensuring that the individuals present in the group seeking to exit the controlled access environment are the same as the individuals that were present upon entering the controlled access environment, wherein if the individuals in the group seeking to exit the controlled access environment are the same as those that were present upon entering the controlled access environment as depicted in the provided visual representation, the group is allowed to exit the controlled access environment.

Yet another aspect of the present invention is to provide a method of increasing security at a controlled access environment and includes: providing one or more authorized individuals and an environment; restricting access to the environment by the one or more authorized individuals, thereby defining a controlled access environment; imaging each group of individuals seeking to access the controlled access environment; creating a visual representation of each group of individuals seeking to access the controlled access environment; providing at least one member of each group of individuals seeking to access the controlled access environment with the visual representation of that particular group; allowing each group access to the controlled access environment, whereby when the particular group seeks to exit the controlled access environment the particular group presents the provided visual representation to one or more of the authorized individuals; and comparing the number of individuals in the particular group seeking to exit the controlled access environment with the number of individuals depicted in the visual representation provided to the particular group, thereby ensuring that the number of individuals in the particular group exiting the controlled access environment is the same as the number of individuals in the particular group that were present upon entering the controlled access environment, wherein if the number of individuals in the particular group seeking to exit the controlled access environment is the same as the number that were present upon entering the controlled access environment as depicted in the provided visual representation, the group is allowed to exit the controlled access environment, otherwise; detaining the particular group of individuals seeking to exit the controlled access environment for further investigation.

These and other features of the invention will be further understood and appreciated by those skilled in the art by reference to the following written specification, claims and appended drawings.

### BRIEF DESCRIPTION OF THE DRAWINGS

FIG. 1 is a flow chart outlining a method of increasing security in a controlled access environment according to an embodiment of the present invention.

### DETAILED DESCRIPTION OF PREFERRED EMBODIMENT

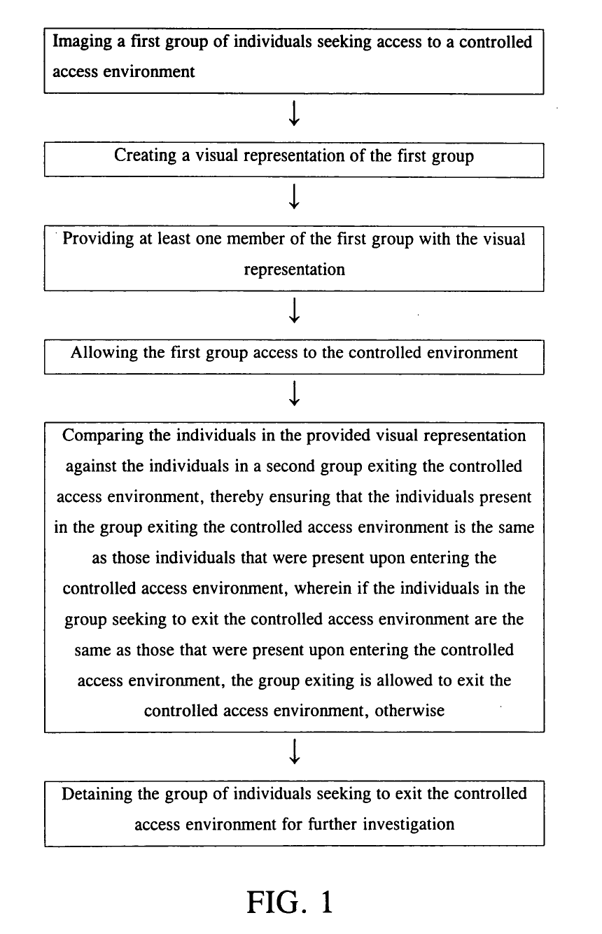

With respect to FIG. 1, the illustration generally designates a method for preventing child abduction and/or increasing security for a group of people attending a controlled access environment and includes imaging a group of people seeking access to a controlled access environment, wherein at least one member of the group is provided with the resultant image. The group is then allowed access to the controlled access environment. However, once the group seeks to exit the controlled access environment the image that was provided in the previous step is compared to the group of people seeking to exit, wherein the comparison will typically entail comparing the number of group members seeking to exit the controlled access facility, to the number of group members recorded in the provided image. Additionally, the identity of the group members seeking to exit the controlled access environment can be compared to the identity of the group members previously imaged. If the number of individuals seeking to exit the group and/or their identity remain the same, the group is allowed to exit the controlled access environment. Otherwise, the group of individuals is detained for further investigation to determine why the number and/or identity of one or more individuals has changed, thereby providing increased security for the group of individuals by insuring that each member of the group seeking to leave the controlled access environment is accounted for as well as insuring that all individuals of the group are the same individuals which earlier entered the controlled access environment. By this method, child abductions, lost children or other associated problems are prevented. Additionally, the operators of the controlled environment are provided with another revenue source and/or promotional tool, as the provided image may be sold or given to one or more members of the group, thereby providing the group with a souvenir.

The imaging step of the inventive method comprises imaging a group of people who are seeking access to a controlled access environment. As used herein, the term imaging is meant to include any method, device or software that is used to capture an image. That is to say a method, technique or apparatus which is capable of graphically representing the group of people and includes, but is not limited to, cameras (film or digital), videos, sketches, imaging software, imaging equipment and the like. As used herein controlled access environment is meant to include an environment wherein the access thereto is controlled or restricted such that only specified individuals or groups are permitted to enter. For example, amusement parks, theme parks, museums and the like. Although these environments are typically restricted by selling tickets and therefore restricting the environment to paying customers, the inventive method is not meant to be so limited. Further, although the steps of the inventive method have been sequentially described, the particular sequence of the steps is not critical to the overall concept and the inventive method is not meant to be limited to the particular sequence unless so limited by the claims.

Subsequent to the imaging step, a visual representation of the imaged group of people is created. The visual representation may take on various forms. However, in the preferred embodiment a camera is used to capture the image and the visual representation will be in the form of a picture. Of course, other methods and devices may be used to capture the image and other visual representations may be used. For example, the provided image may be a sketch or other artistic rendering, a motion picture, movie, a digital representation or the like.

Once the visual representation or image is created, at least one member of the group is provided with the image. Providing the image to a member of the group can be done either before, during or after access to the controlled environment is gained. In one embodiment, the group of people seeking access to the environment will be photographed before access to the environment. For example, a group of people seeking to access an amusement park may be photographed while waiting in line, wherein the photograph is provided to one of the members of the group upon paying the required admittance fee. In another embodiment, the photograph can be taken after the members of the group have paid the required admittance fee, wherein the photograph is provided thereafter. Of course, the photograph may be taken of the group and supplied thereto at any time as long the photograph or other image is provided or made available to the group before exiting the environment as discussed in more detail below. Once the group of people are allowed access to the environment, the group is free to use the facilities and remain therein as determined by the rules and regulations of the party or organization controlling the access to the environment.

Upon exiting the environment the provided image is supplied to the party or organization restricting access and compared to the group seeking to exit the environment. The comparison may take on various forms. However, in one embodiment both the number of individuals of the group seeking to exit the environment is compared to the provided image and the identity of each member of the group is compared to the identity of the individuals within the provided image. Through this comparison it is assured that the group seeking to exit includes the same number of people upon exiting the environment as were present upon entering, thereby ensuring that no member of the group had been inadvertently left behind or that no new members have been added. In addition, by comparing the identity of the group of individuals seeking to exit the environment to the provided image, it is insured that the same individuals are exiting the environment as were allowed access, thereby ensuring that no member of the group was either inadvertently or purposefully exchanged, captured or abducted. Consequently, if the same number of individuals are present in the group seeking to leave the environment and/or the identity of those individuals remains the same, the group is allowed to exit the environment without further recourse. Additionally, the provided image may be offered to one or more of the individuals of the group for a fee, thereby providing the party restricting access with an additional revenue source. Of course, the visual representation may be given to one or more members of the group without a fee, on a complementary basis. Alternatively, the visual representation may be used for some other commercial or private endeavor.

If the same number of individuals and/or their identity has changed from when the group entered the environment, one or more members of the group may be detained for further investigation. In the preferred embodiment, the members of the group would be questioned to ensure that no member of the group was inadvertently left behind and/or that all members of the group are present and are leaving the environment on their own accord. Of course, the individuals need not be detained and may instead simply be questioned or reported to the proper authorities, another agency or the like. For example, the individuals could be reported to a police or other regulating agency.

The inventive method can be used wherever access to an environment is restricted in some manner, such that the restricting party is able to compare a visual representation of a group of individuals exiting the environment to the visual representation of the group of individuals seeking entrance to the environment. Such a method is particularly useful for hotels, resorts, water parks, theme parks, amusement parks, museums or any place that sells tickets before allowing access to the environment, and provides an additional security measure both to the group of individuals seeking access to the environment and to the party or organization restricting access thereto. The additional security measure is accomplished in a simple manner, whereby the group of people seeking entrance to the environment is photographed and the photograph is compared to the group of people seeking to exit the environment to ensure that the same number of individuals and/or the identity thereof has remained the same. Additionally, the photograph or other visual representation of the group of people may be used by the party restricting access for additional revenue sources and/or the development of their clients goodwill.

The inventive method provides increased security while being more proactive than relying on video footage. Further, the inventive security measure is less intrusive and is packaged in a manner that does not render the feeling of an Orwellian totalitarian system. Further yet, the inventive method can be used or sold as a fun safety device, whereby the images can include differing themes to encourage the overall entertaining aspects of the invention.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A method of preventing child abductions from a group of individuals seeking admittance to a controlled access environment, comprising:
imaging a first group of individuals seeking access to a controlled access environment;
creating a visual representation of the first group;
allowing the first group access to the controlled environment; and
comparing the individuals in the visual representation against the individuals in a second group seeking to exit the controlled access environment, thereby ensuring that the same individuals present in the group exiting the controlled access environment are the same as those that were present upon entering the controlled access environment, wherein if the number of individuals in the group seeking to exit the controlled access environment is the same as those present upon entering the controlled access environment, the group seeking to exit is allowed to exit the controlled access environment.

2. The method according to claim 1, wherein the imaging step comprises taking a photograph of the first group of individuals.

3. The method according to claim 2, wherein the creating step comprises printing the photograph and the providing step includes providing the photograph to the first group.

4. The method according to claim 1, wherein the comparing step further comprises:
comparing the number of individuals in the provided visual representation against the number of individuals in the second group seeking to exit the controlled access environment.

5. The method according to claim 1, wherein the comparing step comprises:
comparing the identity of the individuals in the visual representation against the identity of the individuals in the second group exiting the controlled access environment, thereby ensuring that the identity of the individuals in the second group is that same as the identity of the individuals in the first group.

6. The method according to claim 1, wherein the controlled access environment is an amusement park.

7. The method according to claim 2, wherein the first group of individuals comprises more than one individual.

8. The method according to claim 1, comprising:
providing at least one member of the first group with the visual representation.

9. The method according to claim 1, wherein if the individuals in the group seeking to exit the controlled access environment are not the same as those present upon entering the controlled access environment, the group seeking to exit is detained for further investigation.

10. The method according to claim 1, wherein if the individuals in the group seeking to exit the controlled access environment are not the same as those present upon entering the controlled access environment, the group seeking to exit is questioned to determine why the individuals are not the same.

11. The method according to claim 1, wherein if the individuals in the group seeking to exit the controlled access environment are not the same as those present upon entering the controlled access environment, the group seeking to exit is reported to the proper authorities.

12. A method of preventing child abductions from a group of individuals seeking admittance to a controlled access environment, comprising:
providing one or more authorized individuals and an environment;
restricting access to the environment by the one or more authorized individuals, thereby defining a controlled access environment;
imaging a group of individuals seeking to access the controlled access environment;
creating a visual representation of the group;
providing at least one member of the group with the visual representation;
allowing the group access to the controlled access environment, whereby when the group seeks to exit the controlled access environment the group presents the visual representation to one or more of the authorized individuals; and
comparing the individuals in the group seeking to exit the controlled access environment with the individuals depicted in the provided visual representation, thereby ensuring that the individuals present in the group seeking to exit the controlled access environment are the same as the individuals that were present upon entering the controlled access environment, wherein if the individuals in the group seeking to exit the controlled access environment are the same as those that were present upon entering the controlled access environment as depicted in the provided visual representation, the group is allowed to exit the controlled access environment.

13. The method according to claim 12, wherein the imaging step comprises taking a photograph of the group of individuals.

14. The method according to claim 13, wherein the creating step comprises printing the photograph and the providing step includes providing the photograph to the group.

15. The method according to claim 12, wherein the comparing step further comprises: comparing the number of individuals in the provided visual representation against the number of individuals in the second group seeking to exit the controlled access environment.

16. The method according to claim 12, wherein the comparing step comprises:
comparing the identity of the individuals in the provided visual representation against the identity of the individuals in the group exiting the controlled access environment, thereby ensuring that the identity of the individuals in the group exiting the environment is that same as the identity of the individuals in the group that entered the environment.

17. The method according to claim 12, wherein the controlled access environment is an amusement park.

18. The method according to claim 12, wherein the group of individuals comprises more than one individual.

19. The method according to claim 12, wherein if the individuals in the group seeking to exit the controlled access environment are not the same as those present upon entering the controlled access environment, the group seeking to exit is detained for further investigation.

20. A method of increasing security at a controlled access environment, comprising:
providing one or more authorized individuals and an environment;
restricting access to the environment by the one or more authorized individuals, thereby defining a controlled access environment;
imaging each group of individuals seeking to access the controlled access environment;
creating a visual representation of each group of individuals seeking to access the controlled access environment;
providing at least one member of each group of individuals seeking to access the controlled access environment with the visual representation of that particular group;
allowing each group access to the controlled access environment, whereby when the particular group seeks to exit the controlled access environment the particular group presents the provided visual representation to one or more of the authorized individuals; and
comparing the number of individuals in the particular group seeking to exit the controlled access environment with the number of individuals depicted in the visual representation provided to the particular group, thereby ensuring that the number of individuals in the particular group exiting the controlled access environment is the same as the number of individuals in the particular group that were present upon entering the controlled access environment, wherein if the number of individuals in the particular group seeking to exit the controlled access environment is the same as the number that were present upon entering the controlled access environment as depicted in the provided visual representation, the group is allowed to exit the controlled access environment, otherwise;
detaining the particular group of individuals seeking to exit the controlled access environment for further investigation.

21. The method according to claim 20, wherein the imaging step comprises taking a photograph of each group of individuals.

22. The method according to claim 21, wherein the creating step comprises printing the photograph of the particular group and the providing step includes providing the photograph to the particular group.

23. The method according to claim 21, wherein the comparing step comprises:
comparing the identity of the individuals in the provided visual representation against the identity of the individuals in the particular group exiting the controlled access environment, thereby ensuring that the identity of the individuals in the particular group exiting the environment is that same as the identity of the individuals in the group that entered the environment.

24. The method according to claim 21, wherein the controlled access environment is an amusement park.

25. The method according to claim 21, wherein the group of individuals comprises more than one individual.
